(19) United States
(12) Patent Application Publication
(10) Pub. No.: US 2014/0078040 A1
(43) Pub. Date: Mar. 20, 2014

(54) DUAL-MODE REMOTE CONTROL METHOD

(71) Applicant: WISTRON CORPORATION, New Taipei City (TW)

(72) Inventors: Sheng-Hsien Hsieh, New Taipei City (TW); Shou-Te Wei, New Taipei City (TW); Sheng-Hua Chou, New Taipei City (TW); Pin-Hong Liou, New Taipei City (TW); Che-You Kuo, New Taipei City (TW); Chih-Hao Huang, New Taipei City (TW); Hsun-Chih Tsao, New Taipei City (TW)

(73) Assignee: Wistron Corporation, New Taipei City (TW)

(21) Appl. No.: 13/729,032

(22) Filed: Dec. 28, 2012

(30) Foreign Application Priority Data
Sep. 19, 2012 (TW) 101134316

(51) Int. Cl. G06F 3/01

(52) U.S. Cl. CPC G06F 3/017
USPC 345/156

(57) ABSTRACT

A dual-mode remote control method, adapted to an electronic apparatus having an image sensor, is provided. In the method, the image sensor is used to successively capture a plurality of images. Then, infrared ray (IR) detection and/or gesture detection is determined according to at least one characteristic of the images and performed on the images, so as to obtain an action of at least one target in the images. Finally, a control command corresponding to the action is executed.

### CROSS-REFERENCE TO RELATED APPLICATION

This application claims the priority benefit of Taiwan application serial no. 101134316, filed on Sep. 19, 2012. The entirety of the above-mentioned patent application is hereby incorporated by reference herein and made a part of this specification.

### BACKGROUND

1. Field of the Present Invention

The present invention is directed to a remote control method and more particularly, to a remote control method combining infrared ray (IR) detection and gesture detection.

2. Description of Related Art

With development of technology, consumer electronic products are continuously launched to the market. These electronic products not only provide various functions but also have changed life styles of modern people. For example, in a home environment, electrical products such as a TV, a hi-fi device, a digital video disc (DVD) player, an air conditioner, an electric fan, may be placed in the living room. To provide convenience for users to operate, each of the electrical appliances is sold accompanying with a remote controller by the venders, which allows the users to control their electrical appliances without getting up while sitting on the sofa.

However, as the number of electrical appliances increases, more and more remote controllers would appear in home, which results in a burden that the user has to find out the corresponding remote controller before he/she uses the electrical appliance. Moreover, the operation method of the remote controller is limited to key operation, and the design and operation method of each vender or each electrical appliance are all different, and as a result the user has to learn how to operate the remote controller before using it. Thus, users are often bothered by the usage and operation methods of typical remote controllers.

In view of the above, many intuitive remote control methods are developed in the industry, for example, infrared ray (IR) remote control and gesture remote control. In an application of the IR remote control, the user may wave an IR light source toward an electrical appliance (e.g. a TV), and a movement trace of the IR light source may be detected by an image sensor equipped in the electrical appliance so as to be transformed into a corresponding control command for controlling the electrical appliance to execute a function correspondingly. Similarly, in an application of the gesture remote control, the user may directly wave his/her hand in front of the electrical appliance, and a movement trace of the hand may be detected by the image sensor equipped in the electrical appliance and recognized as a gesture so as to be transformed into a corresponding control command for controlling the electrical appliance to execute a function correspondingly. Nevertheless, both of the foregoing remote control methods still have disadvantages, respectively. That is, as for the IR remote control, the user has to hold an IR light source, and as for the gesture remote control, the recognition accuracy is not high enough and an electrical malfunction may occur due to misjudgment.

### SUMMARY

Accordingly, the present invention is directed to a dual-mode remote control method capable of combining infrared ray (IR) detection and gesture detection so as to provide a more accurate manner for remote control.

The present invention provides a dual-mode remote control method adapted to an electronic apparatus having an image sensor. In the method, a plurality of images are successively captured by using the image sensor. Then, IR detection and/or gesture detection is determined according to at least one characteristic of the images and performed on the images so as to obtain an action of at least one target in the images. Finally, a control command corresponding to the action is executed.

In an embodiment of the present invention, the step of successively capturing the images by using the image sensor includes capturing the images by alternatively using a first exposure value and a second exposure value, wherein the first exposure value is smaller than the second exposure value.

In an embodiment of the present invention, the step of determining to perform the IR detection and/or the gesture detection on the images according to the image characteristics and performing the determined detection on the images so as to obtain the actions of the targets in the images includes performing the IR detection on the images which are captured by using the first exposure value so as to obtain an action of an IR light source and performing the gesture detection on the images which are captured by using the second exposure value so as to obtain a gesture.

In an embodiment of the present invention, the step of determining to perform the IR detection and/or the gesture detection on the images according to the image characteristics so as to obtain the actions of the targets in the images includes synchronously performing the IR detection and the gesture detection on the images so as to obtain an action of an IR light source and a gesture in the images.

In an embodiment of the present invention, the step of determining to perform the IR detection and/or the gesture detection on the images according to the image characteristics so as to obtain the actions of the targets in the images includes binarizing the images and performing the IR detection on the binarized images so as to obtain the action of the IR light source in the images and performing the gesture detection on the original images so as to obtain the gesture in the images.

In an embodiment of the present invention, before the step of binarizing the images, the method further includes exposing the image sensor to generate a background image, disposing a light source within a sensing range of the image sensor and exposing the image sensor to generate a light point image, and then, determining a first threshold to binarize the images by using the difference image.

In an embodiment of the present invention, the step of determining to perform the IR detection and/or the gesture detection on the images according to the at least one characteristic of the images so as to obtain the action of the at least one target in the images includes finding out a feature in the images, of which a luminance is higher than a second threshold and recognizing a movement trace of the feature in the images as an action of an IR light source.

In an embodiment of the present invention, the step of determining to perform the IR detection and/or the gesture detection on the images according to the at least one characteristic of the images so as to obtain the action of the at least one target in the images includes finding out a feature of a hand in the images and recognizing a movement trace of the feature as a gesture.

In an embodiment of the present invention, the step of determining to perform the IR detection and/or the gesture detection on the images according to the at least one characteristic of the images so as to obtain the action of the at least one target in the images includes determining whether a feature having a luminance higher than a third threshold exists in the images. If the feature exists, whether an amount of movement of the feature is higher than a fourth threshold is determined, and if the amount of movement of the feature is further higher than a fourth threshold, a IR detection mode is entered, and the IR detection is performed on the images so as to obtain an action of an IR light source in the images.

In an embodiment of the present invention, after the step of determining whether the feature having a luminance higher than a third threshold exists in the images, the method further includes, if the feature does not exist, entering a gesture detection mode and performing the gesture detection on the images so as to obtain a gesture in the images.

In an embodiment of the present invention, after the step of determining whether the amount of movement of the feature is higher than the fourth threshold, the method further includes, if the amount of movement of the feature is not higher than the fourth threshold, entering a gesture detection mode and performing the gesture detection on the images so as to obtain a gesture in the images.

In an embodiment of the present invention, after the step of entering the IR detection mode and performing the IR detection on the images so as to obtain the action of the IR light source of the at least one target in the images so as to obtain the action of the at least one target in the images, the method further includes determining whether the luminance of the feature is lower than a fifth threshold and if true, entering a gesture detection mode and performing the gesture detection on the images so as to obtain a gesture in the images.

To sum up, in the dual-mode remote control method of the present invention, a plurality of images is successively captured by using the image sensor, and according to the characteristics of the captured images, the IR detection and/or the gesture detection is selected to detect the action of the target in the images, such that the control command is determined based on the result from the two detection methods. Accordingly, a more accurate and convenient remote control method is provided to users.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the present invention.

FIG. 1 is a flowchart of a dual-mode remote control method according to an embodiment of the present invention.

FIG. 2 is a flowchart of a dual-mode remote control method according to another embodiment of the present invention.

FIG. 3 illustrates an example of a dual-mode remote control method according to another embodiment of the present invention.

FIG. 4 a flowchart of dual-mode remote control method according to still another embodiment of the present invention.

FIG. 5(a)˜FIG. 5(c) are examples of establishing binarization thresholds according to an embodiment of the present invention.

FIG. 6 illustrates an example of a dual-mode remote control method according to still another embodiment of the present invention.

FIG. 7 a flowchart of dual-mode remote control method according to yet another embodiment of the present invention.

### DESCRIPTION OF EMBODIMENTS

In both infrared ray (IR) detection and gesture detection, images are captured by using an image sensor and processed to achieve IR remote control and gesture remote control functions. Accordingly, in the present invention, an image sensor having a wider spectrum than typical sensors and capable of detecting invisible IR is adopted to capture images of a user operating an electronic apparatus and IR detection and gesture detection are further performed on the captured images. When performing the remote control, an action of a target is determined by combining detection results of the two types of detection, and a corresponding control command is executed. Thus, the accuracy of the electronic apparatus determining the remote control operation of the user is improved.

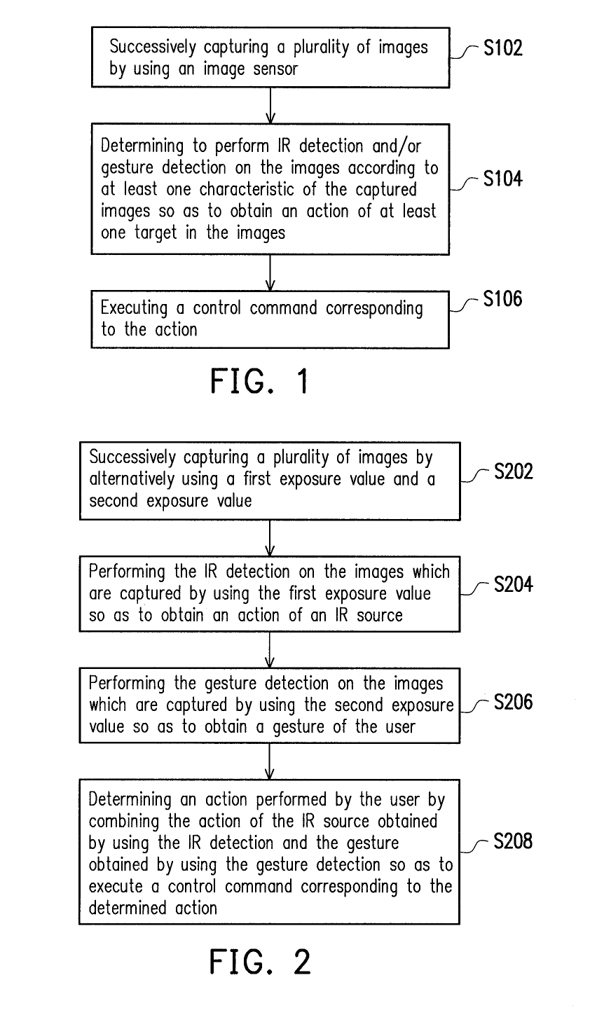

FIG. 1 is a flowchart of a dual-mode remote control method according to an embodiment of the present invention. Referring to FIG. 1, the method illustrated in the present embodiment is adapted to an electronic apparatus having an image sensor. Such electronic apparatus is, for example, a home electrical appliance, such as a TV, a hi-fi device, a digital video disc (DVD) player, an air conditioner, an electric fan and so forth, or a portable device, such as a mobile phone, a desktop computer, a notebook computer (NB), a tablet computer (tablet PC) and so on. The image sensor equipped in the electronic apparatus is, for example, a charge coupled device (CCD) sensor or a complementary metal-oxide semiconductor (CMOS) sensor, which has a spectrum covering visible light and invisible light so as to detect IR emitted from an IR light source. The steps of the dual-mode remote control method of the present embodiment are as follows.

First, a plurality of images are successively captured by the electronic apparatus using the image sensor (step S102). The images captured by the image sensor are, for example, temporarily stored in a memory of the electronic apparatus for subsequent processing.

Then, the electronic apparatus determines to perform IR detection and/or gesture detection on the images according to at least one characteristic of the captured images, so as to obtain an action of at least one target in the images (step S104). For instance, the electronic apparatus may determine the IR detection and/or the gesture detection to be performed by examining luminance of each pixel in the captured images. When a plurality of pixels in the captured images are detected to have high luminance, the electronic apparatus may determine that an IR light source is detected so as to perform the IR detection to track a movement trace of the IR light source in the images and recognize the same as an action of an IR light source. On the other hand, when no pixel in the captured images is detected to have high luminance, the electronic apparatus may determine that no IR light source exists in the captured images so as to perform the gesture detection to track a movement trace of a user's hand in the images and recognize the same as a gesture.

Finally, according to the action of the target (i.e. the IR light source and/or the gesture) obtained by performing the IR detection and/or the gesture detection, the electronic apparatus executes a control command corresponding to the action (step S106) so as to achieve remote control for the electronic apparatus. The corresponding relationship between the target action and the control command is, for example, recorded in a command mapping table which is built in the apparatus or defined by the user so that after the action of the target is recognized, the electronic apparatus may inquire the command mapping table and accordingly execute the corresponding control command so as to achieve remote control. Additionally, after executing the control command, the electronic apparatus keeps capturing images by using the image sensor to detect a next remote control operation of the user.

By the remote control method described above, the electronic apparatus may recognize the user performs the remote control by using the IR light source or the gesture in advance and may also combine the detection results of both methods in the final execution of the control command. Thereby, the accuracy of the electronic apparatus determining the remote control operation may be improved.

It is to be mentioned that, as for the remote control method combining the IR detection with the gesture detection, a hardware alternative method, software synchronizing method and dual-mode switching method are further implemented in the present invention so as to provide a more adaptive method to implement the remote control operation for electronic apparatuses having different specifications. Embodiments corresponding to the aforesaid methods are respectively exemplified hereinafter.

### Hardware Alternating Method

FIG. 2 is a flowchart of a dual-mode remote control method according to another embodiment of the present invention. Referring to FIG. 2, the method of the present embodiment is adapted to an electronic apparatus having an image sensor and includes steps as follows.

First, the electronic apparatus controls the image sensor thereof to successively capture a plurality of images by alternatively using a first exposure value (EV) and a second EV (step S202), wherein the first EV is smaller than the second EV. In detail, according to a frame per second (FPS) of the image sensor capturing the images, the electronic apparatus may determine a frequency for alternatively using the exposure values. For example, when the FPS of the image sensor is 60 frames per second, the frequency for alternating the exposure values is 1/60 seconds.

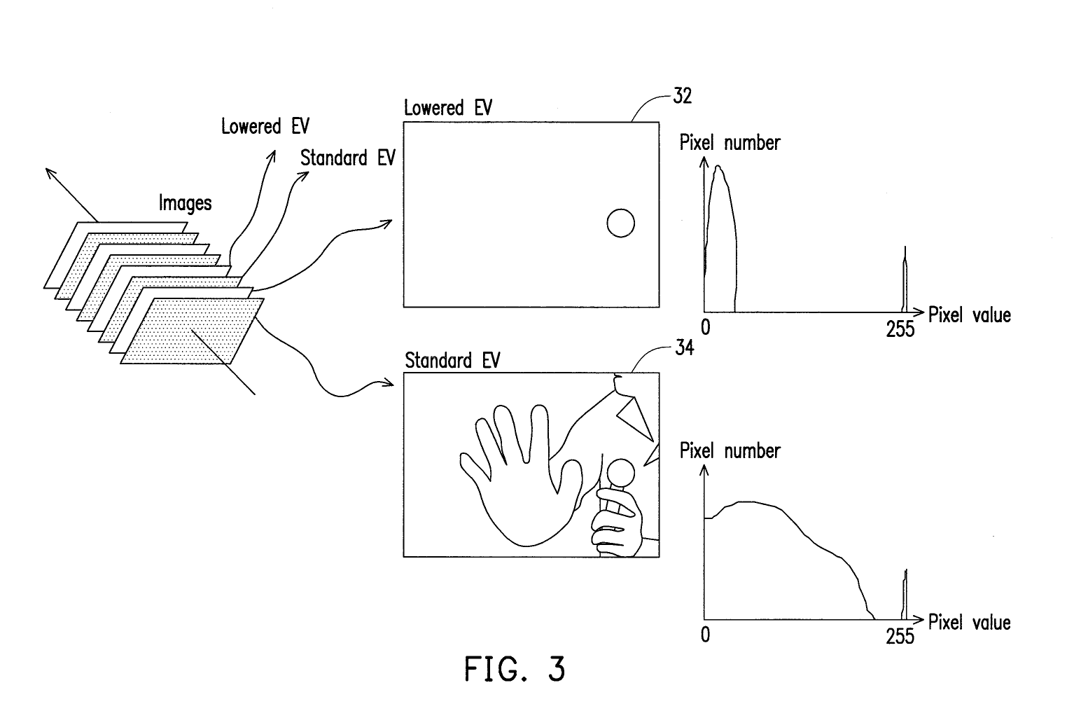

For instance, FIG. 3 illustrates an example of a dual-mode remote control method according to another embodiment of the present invention. Referring to FIG. 3, when successively capturing images, the electronic apparatus may capture the images by alternatively using a standard EV and lowered EV. Therein, an image 32, for example, is obtained when the lowered EV is used to capture the image. Meanwhile, referring to the image 32 and a pixel value histogram thereof, pixel values of the image 32 are distributed in two groups, wherein the pixels in a bright group have pixel values approximate to the maximum value (i.e. the brightest value) of 255. Otherwise, an image 34, for example, is obtained when the standard EV is used to capture the image. Referring to the image 34, a gesture which the user holds the IR light source is faintly visible while an image showing the other hand of the user is also obvious. Referring to a pixel value histogram of the image 34, except for the bright group corresponding to the IR light source among the pixel values of the image 34, the rest of pixel values are averagely distributed between 0 and 255. Since the image 34 has more details, the electronic apparatus may further perform the gesture detection on the image 34 so as to recognize the gesture implemented by the user in the image 34.

Then, the electronic apparatus performs the IR detection on the images which are captured by using the first EV so as to obtain the action of the IR light source (step S204). For example, the electronic apparatus may set a threshold of luminance for the IR light source, and such threshold is used for determining whether the pixels are from the IR light source when performing the IR detection on the images. In detail, the electronic apparatus may, for example, find out a feature having a luminance value higher than the threshold in the images, and determine the action of the IR light source according to the movement trace of the feature in the images.

On the other hand, the electronic apparatus may also perform the gesture detection on the images which are captured by using the second EV so as to obtain a gesture of the user (step S206). For example, according to a pre-established feature database, the electronic apparatus may compare an objective in the images with several hand features respectively so as to find out the hand feature in the images and use the movement trace of the feature as the gesture.

Finally, through combining the action of the IR light source obtained by performing the IR detection and the gesture obtained by performing the gesture detection, the electronic apparatus may determine the user's operation action and accordingly executes a control command corresponding to the operation action (step S208). Thereby, the accuracy of the remote control operation may be improved.

### Software Synchronizing Method

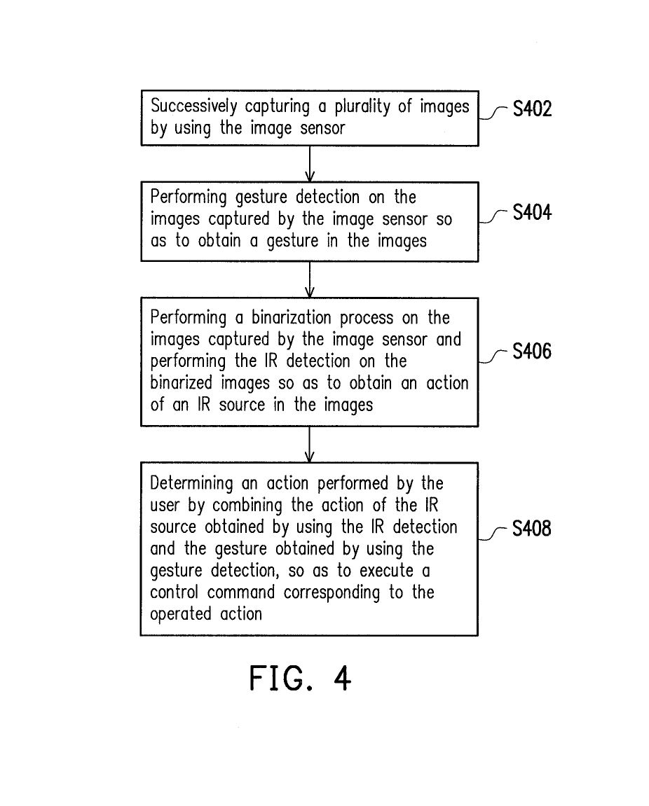

FIG. 4 a flowchart of dual-mode remote control method according to another embodiment of the present invention. Referring to FIG. 4, the method of the present embodiment is adapted to an electronic apparatus having an image sensor and includes steps as follows.

First, the electronic apparatus successively captures a plurality of images by using the image sensor (step S402). Then, the electronic apparatus synchronously performs the IR detection and the gesture detection on the captured images so as to obtain an action of an IR light source and a gesture in the images.

In detail, the electronic apparatus may perform the gesture detection on the images originally captured by the image sensor so as to obtain the gesture in the images (step S404). The technical details of the electronic apparatus detecting the gesture have been described in the preceding embodiment and therefore will not be repeated hereinafter.

On the other hand, while performing the gesture detection, the electronic apparatus may also perform a binarization process on the images (step S406) and perform the IR detection on the binarized images so as to obtain the action of the IR light source in the images (step S408). Before performing the binarization process, the electronic apparatus may, for example, set a threshold to be used in the binarization process.

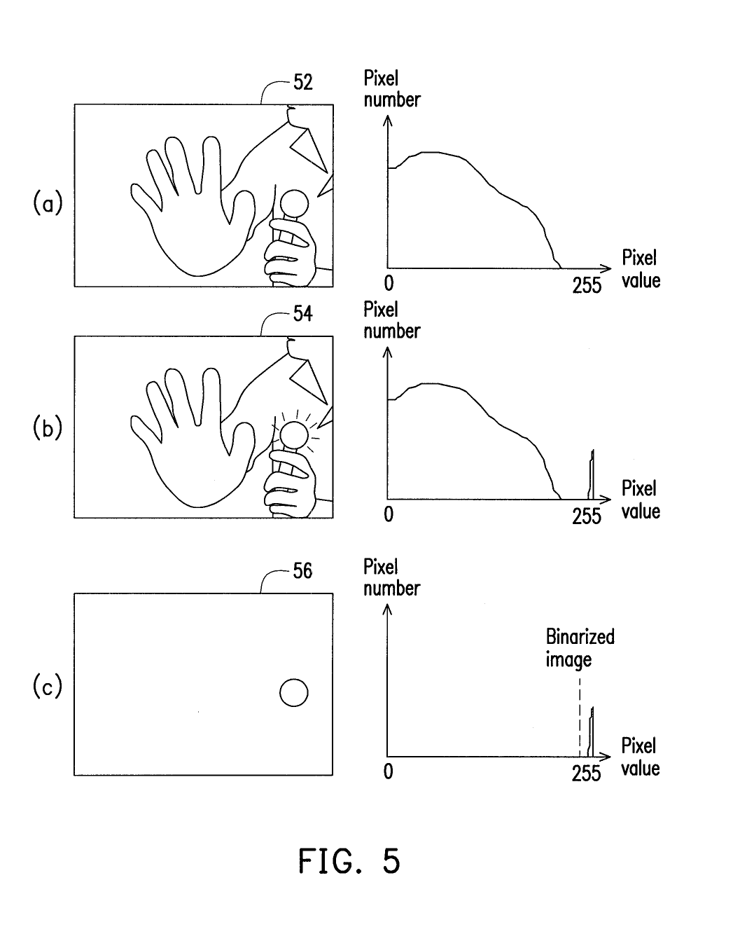

For instance, FIG. 5(a)˜FIG. 5(c) are examples of establishing a binarization threshold according to an embodiment of the present invention. Referring to FIG. 5(a)˜FIG. 5(c), in the present embodiment, the user controls the electronic apparatus to expose the image sensor of the electronic apparatus so that a background image 52 is generated, as shown in FIG. 5(a). Then, the user disposes a light source within a sensing range of the image sensor (in the present embodiment, the light source is turned on by the user) and exposes the image sensor of the electronic apparatus so that a light point image 54 is generated, as shown in FIG. 5(b). Afterward, the background image is subtracted from the light point image by the electronic apparatus so that a difference image 56 is generated, as shown in FIG. 5(c). Finally, the electronic apparatus may determine the threshold for binarizing the images by using the difference image. Therein, the electronic apparatus may, for example, find out an average of luminance values in the difference image and use the same as the binarization threshold to distinguish the light source from the background image, wherein the luminance values are lower than those in the bright group and may be obviously distinguished from other groups.

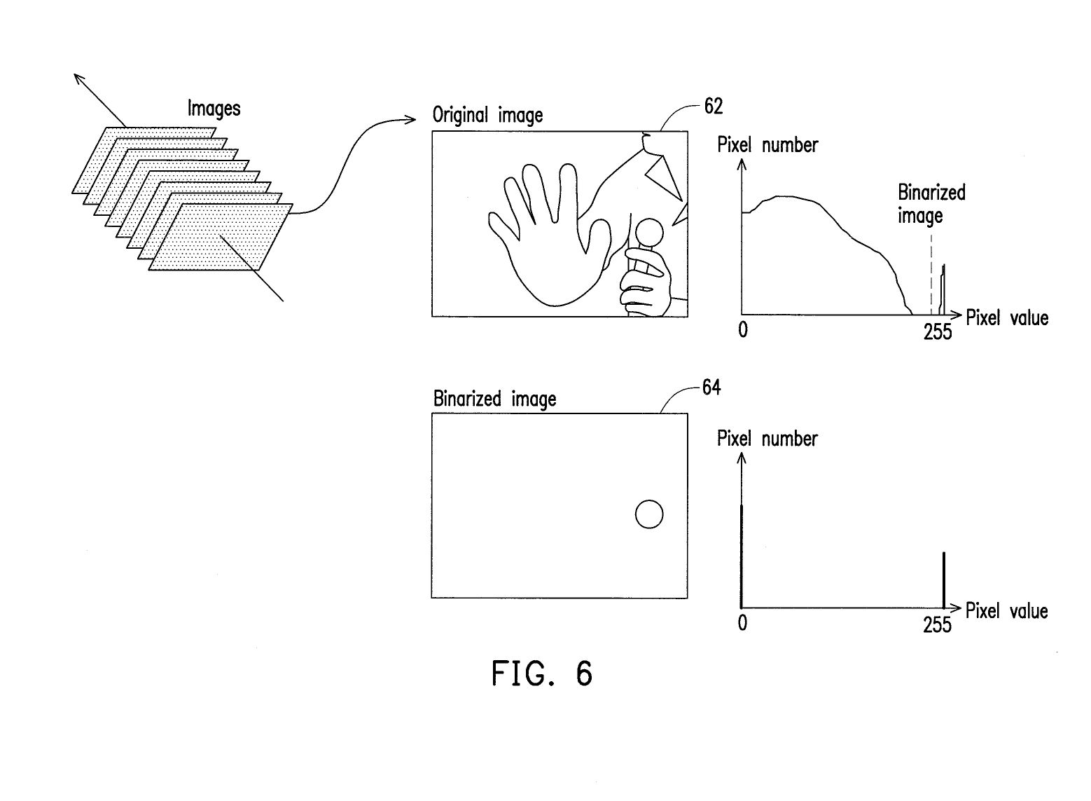

After the binarization threshold is determined, the binarization process is performed on the images which are captured by the image sensor together with and the IR detection. For instance, FIG. 6 illustrates an example of a dual-mode remote control method according to another embodiment of the present invention. Referring to FIG. 6, the electronic apparatus may, for example, binarize an original image 62 that is successively captured by the image sensor by using the binarization threshold to classify pixel values of the pixels therein into two types, 0 and 255. Therein the electronic apparatus may, for example, classify the pixels in the original image 62 having the pixel values higher than the binarization threshold into the bright group (i.e. the group having the pixel value of 255) and classify the pixels having the pixel values smaller than or equal to the binarization threshold into the a dark group (i.e. the group having the pixel value of 0) so that a binarized image 64 is obtained. Referring to a pixel value histogram of the image 64, a distribution of the pixel values of the image 64 merely includes two groups of pixel values, 0 and 255. Since the image 64 is merely classified into the bright group and the dark group, the electronic apparatus may easily detect the movement trace of the feature of the bright group so that the action performed by the user on the IR light source in the image 64 may be recognized.

Finally, the electronic apparatus may determine the action operated by the user according to the combination of the action of the IR light source obtained by performing the IR detection and the gesture obtained by performing the gesture detection so as to execute the control command corresponding to the operated action (step S410).

With the binarization process, the IR light source in the images may be clearly distinguished. At this time, if the movement trace of the IR light source is further detected, a more accurate action of the IR light source may be obtained. Thereby, the accuracy of the electronic apparatus determining the remote control operation of the user may be improved.

### Dual-Mode Switching Method

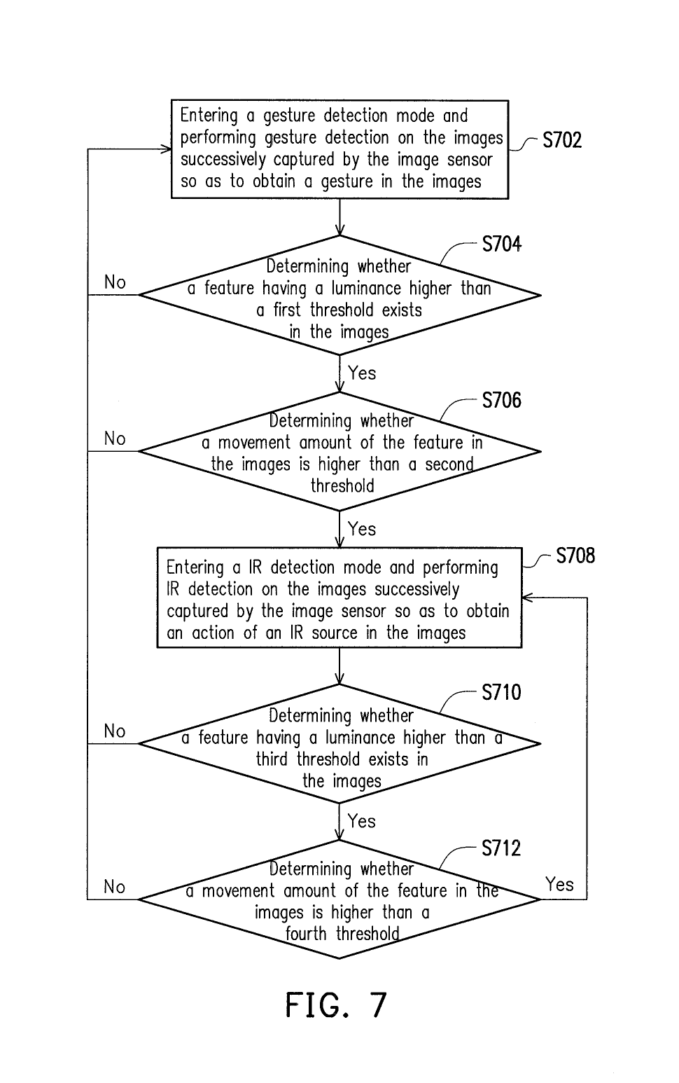

FIG. 7 a flowchart of dual-mode remote control method according to yet another embodiment of the present invention. Referring to FIG. 7, the method of the present embodiment is adapted to an electronic apparatus having an image sensor and includes steps as follows.

First, the electronic apparatus may, for example, enter a gesture detection mode and perform gesture detection on a plurality of images successively captured by the image sensor so as to obtain a gesture in the images (step S702). During the process of the gesture detection, the electronic apparatus may determine whether a feature having luminance higher than a first threshold exists in the images (step S704) so as to determine whether an IR light source appears in the images. The first threshold is, for example, the threshold to be used in the binarization process on the images in the preceding embodiment, which will not be repeatedly described herein.

If the electronic apparatus determines that no feature having the luminance higher than the first threshold exists in the images, it may be inferred that no IR light source is appeared in the images. Thus, the electronic apparatus remains in the gesture detection mode and performs the gesture detection on the images so as to obtain the gesture in the images. Otherwise, if the electronic apparatus determines that a feature having the luminance higher than the first threshold exists in the images, it may be inferred that the IR light source appears in the images. Further, for distinguishing whether the feature is an IR light source operated by the user or an IR light source disposed within a sensing range of the image sensor without being operated by the user, in the present embodiment, whether a movement amount of the feature in the images is higher than a second threshold is further determined (step S706). The movement amount may be, for example, a distance between positions of a same feature in the former image and in the later image that is detected by the electronic apparatus.

If the electronic apparatus determines that the movement amount of the feature in the images is higher than the second threshold, it is confirmed that the user performs the remote control operation by using the IR light source. Thus, the electronic apparatus enters the IR detection mode and performs the IR detection on the images so as to obtain the action of the IR light source in the images (step S708). Otherwise, if the electronic apparatus determines that the movement amount of the feature in the images is not higher than the second threshold, the feature is confirmed as a light source constantly disposed within the sensing range of the image sensor. Thus, the electronic apparatus remains in the gesture detection mode and performs the gesture detection on the images so as to obtain the gesture in the images.

It is to be mentioned that after entering the IR detection mode, the electronic apparatus may continue to determine whether the feature having the luminance higher than a third threshold exists in the images (step S710) so as to determine whether the IR light source in the images is moved out of the sensing range of the image sensor. When determining that the feature having the luminance higher than the third threshold no longer exists in the images, the electronic apparatus returns to the gesture detection mode and performs the gesture detection on the images so as to obtain the gesture in the images. The third threshold is, for example, smaller than or equal to the first threshold, which is not limited herein.

In addition, the electronic apparatus may continue to determine whether the movement amount of the detected feature in the image is higher than a fourth threshold (step S712) so as to determine whether the operation of the IR light source in the images is stopped. When determining that the movement amount of the feature in the image is not higher than the fourth threshold, the electronic apparatus returns to the gesture detection mode and performs the gesture detection on the images so as to obtain the gesture in the images. The fourth threshold is, for example, smaller than or equal to the second threshold, but is not limited herein.

Additionally, the step S710 and the step S712 may also be independently accorded to determine whether to switch back to the gesture detection mode. Namely, when determining that no feature in the images having the luminance higher than the third threshold, the electronic apparatus determines that the IR light source is moved out of the sensing range of the image sensor and switches back to the gesture detection mode. When determining that the movement amount of the detected feature in the images is not higher than the fourth threshold, the electronic apparatus determines that the user has put the IR light source down or away so as to switch back to the gesture detection mode.

Based on the above, in the dual-mode remote control method of the present invention, a plurality of images are successively captured by the image sensor. The IR detection and/or the gesture detection is determined according to the characteristics of the captured images and performed to detect the actions of the targets in the images. Accordingly, the accuracy of the electronic apparatus determining the remote control operation of the user can be improved. In addition, by using the hardware alternating method, the software synchronizing method and dual-mode switching method to implement the IR detection and the gesture detection, each of the electronic apparatuses having different specifications can be provided with a proper method to achieve the remote control operation.

Although the present invention has been described with reference to the above embodiments, it will be apparent to one of the ordinary skill in the art that modifications to the described embodiment may be made without departing from the spirit of the present invention. Accordingly, the scope of the present invention will be defined by the attached claims not by the above detailed descriptions.

What is claimed is:

1. A dual-mode remote control method, adapted to an electronic apparatus having an image sensor, the method comprising:
successively capturing a plurality of images by the image sensor;
determining to perform an infrared ray (IR) detection and/or a gesture detection on the images according to at least one characteristic of the images so as to obtain an action of at least one target in the images; and
executing a control command corresponding to the action.

2. The dual-mode remote control method according to claim 1, wherein the step of successively capturing the images by the image sensor comprises:
capturing the images by alternatively using a first exposure value and a second exposure value, wherein the first exposure value is smaller than the second exposure value.

3. The dual-mode remote control method according to claim 2, wherein the step of determining to perform the IR detection and/or the gesture detection on the images according to the at least one characteristic of the images so as to obtain the action of the at least one target in the images comprises:
performing the IR detection on the images which are captured by using the first exposure value so as to obtain an action of an IR light source; and
performing the gesture detection on the images which are captured by using the second exposure value so as to obtain a gesture.

4. The dual-mode remote control method according to claim 1, wherein the step of determining to perform the IR detection and/or the gesture detection on the images according to the at least one characteristic of the images so as to obtain the action of the at least one target in the images comprises:
synchronously performing the IR detection and the gesture detection on the images so as to obtain an action of an IR light source and a gesture in the images.

5. The dual-mode remote control method according to claim 4, wherein the step of synchronously performing the IR detection and the gesture detection on the images so as to obtain the action of the IR light source and the gesture in the images comprises:
binarizing the images and performing the IR detection on the binarized images so as to obtain the action of the IR light source in the images; and
performing the gesture detection on the original images so as to obtain the gesture in the images.

6. The dual-mode remote control method according to claim 5, wherein before the step of binarizing the images, the method further comprises:
exposing the image sensor to create a background image;
disposing a light source within a sensing range of the image sensor and exposing the image sensor to generate a light point image;
subtracting the background image from the light point image to obtain a difference image; and
determining a first threshold to binarize the images by using the difference image.

7. The dual-mode remote control method according to claim 1, wherein the step of determining to perform the IR detection and/or the gesture detection on the images according to the at least one characteristic of the images so as to obtain the action of the at least one target in the images comprises:
finding out a feature in the images having a luminance higher than a second threshold and recognizing a movement trace of the feature in the images as an action of an IR light source.

8. The dual-mode remote control method according to claim 1, wherein the step of determining to perform the IR detection and/or the gesture detection on the images according to the at least one characteristic of the images so as to obtain the action of the at least one target in the images comprises:
finding out a feature of a hand in the images and recognizing a movement trace of the feature as a gesture.

9. The dual-mode remote control method according to claim 1, wherein the step of determining to perform the IR detection and/or the gesture detection on the images according to the at least one characteristic of the images so as to obtain the action of the at least one target in the images comprises:
determining whether a feature having a luminance higher than a third threshold exists in the images;
if the feature exists, determining whether an amount of movement of the feature is higher than a fourth threshold; and
if the amount of movement of the feature is higher than the fourth threshold, entering an IR detection mode and performing the IR detection on the images so as to obtain an action of an IR light source in the images.

10. The dual-mode remote control method according to claim 9, wherein after the step of determining whether the feature having the luminance higher than the third threshold exists in the images, the method further comprises:
if the feature does not exist, entering a gesture detection mode and performing the gesture detection on the images so as to obtain a gesture in the images.

11. The dual-mode remote control method according to claim 9, wherein after the step of determining whether the amount of movement of the feature is higher than the fourth threshold, the method further comprises:
if the amount of movement of the feature is not higher than the fourth threshold, entering a gesture detection mode and performing the gesture detection on the images so as to obtain a gesture in the images.

12. The dual-mode remote control method according to claim 9, wherein after the step of entering the IR detection mode and performing the IR detection on the images so as to obtain the action of the at least one target in the images, the method further comprises:
determining whether the luminance of the feature is lower than a fifth threshold; and
if the luminance of the feature is lower than a fifth threshold, entering a gesture detection mode and performing the gesture detection on the images so as to obtain a gesture in the images.
